(19) United States
(12) Patent Application Publication
(10) Pub. No.: US 2007/0217382 A1
(43) Pub. Date: Sep. 20, 2007

(54) Ad hoc network, terminal apparatus, and ad hoc network configuration method used for the same

(75) Inventor: Takeaki Minamizawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/716,705

(22) Filed: Mar. 12, 2007

(30) Foreign Application Priority Data
Mar. 15, 2006 (JP) 070120/2006

(51) Int. Cl. H04L 12/50; H04Q 7/24

(52) U.S. Cl. 370/338; 370/370

(57) ABSTRACT

To provide a portable terminal that can establish an ad hoc network by operating existing communication unit without requiring a burdensome operation of manually exchanging ad hoc setting information. The distribution determination section of a receiving portable terminal compares a message digest that is calculated by a telephone calling application from a received telephone number and one received by the short-distance wireless communication section. If the values of the message digests match, the distribution determination section informs the user that the calling portable terminal is capable of ad hoc communication such as on a liquid crystal display. When an operation assigned to start of ad hoc communication is performed on the receiving portable terminal, the distribution determination section sends ad hoc communication settings information to the short-distance wireless communication section to set the short-distance wireless communication section to ad hoc mode, and transmits the ad hoc communication setting information to the calling portable terminal utilizing communication unit of the telephone calling application.

### BACKGROUND OF THE INVENTION

1. Field of the Invention

The present invention relates to an ad hoc network, a terminal apparatus, an ad hoc network configuration method that is used for the same and a program therefor, and more particularly, to an ad hoc network configuration method that utilizes cellular communication means.

2. Related Art

In recent years, portable phones and Personal Digital Assistants (PDAs) that include short-distance communication means such as wireless Local Area Network (LAN) have been commercially available. Such short-distance communication means often has a communication function capable of establishing an ad hoc network.

To establish a secure ad hoc network among portable terminals that include wireless LAN function, it is traditionally necessary to distribute Wired Equivalent Privacy (WEP) keys and the like for use in encryption beforehand. An ad hoc network is a network that is not established in advance but formed only when actual communication is performed.

Meanwhile, for portable phones, a method is proposed for attempting connection to the other party by Peer-to-Peer (P2P) communication prior to cellular communication in order to check whether the other party is capable of P2P communication when one makes a telephone call by cellular (see Japanese Patent Laid-Open No. 2005-223722, for example).

However, the current situation is that communication over an ad hoc network is rarely utilized with conventional portable phones because of necessity to perform a burdensome operation of manually exchanging ad hoc setting information. The technique described in Japanese Patent Laid-Open No. 2005-223722 enables a user to perform both cellular communication and P2P communication but not establishment of ad hoc communication described above.

### BRIEF SUMMARY OF THE INVENTION

An object of the present invention is therefore to provide an ad hoc network, a terminal apparatus, an ad hoc network configuration method used for the same, and a program therefor that solve the problems outlined above by enabling establishment of an ad hoc network through manipulation of existing communication means without requiring a burdensome operation of manually exchanging ad hoc setting information.

An ad hoc network according to the present invention is an ad hoc network that is formed by a plurality of terminal apparatuses that include a wireless communication function to directly communicate with other terminals and communication means of performing communication over a communication network with the other terminals and is formed by means of the wireless communication function, wherein

a first terminal apparatus comprises means of transmitting via the communication means of the first terminal apparatus a terminal identifier that is determined by the communication means of the first terminal apparatus to a second terminal apparatus, which is a communication party with which the first terminal apparatus wants to form a network, and means of transmitting information on the terminal identifier to the second terminal apparatus by way of the wireless communication function of the first terminal apparatus, and

the second terminal apparatus comprises means of receiving the terminal identifier with the communication means of the second terminal apparatus; means of performing radio scan with the wireless communication function of the second terminal apparatus; means of comparing the terminal identifier received by the communication means of the second terminal apparatus with the information on the terminal identifier received in the radio scan by the wireless communication function of the second terminal apparatus; and means of establishing the network using the wireless communication function when a match is detected in the comparison.

Another ad hoc network according to the present invention is an ad hoc network that is formed by a plurality of terminal apparatuses that include a wireless communication function to directly communicate with other terminals and communication means of performing communication over a communication network with the other terminals and is formed by means of the wireless communication function, wherein

a first terminal apparatus comprises means of transmitting via the communication means of the first terminal apparatus a terminal identifier that is determined by the communication means of the first terminal apparatus to a second terminal apparatus, which is a communication party with which the first terminal apparatus wants to form a network, and means of transmitting the digest of the terminal identifier to the second terminal apparatus by way of the wireless communication function of the first terminal apparatus, and

the second terminal apparatus comprises means of receiving the terminal identifier with the communication means of the second terminal apparatus; means of performing radio scan with the wireless communication function of the second terminal apparatus; means of calculating the digest of the terminal identifier received by the communication means of the second terminal apparatus; means of comparing the calculated digest of the terminal identifier with the digest of the terminal identifier received in the radio scan by the wireless communication function of the second terminal apparatus; and means of establishing the network using the wireless communication function when a match is detected in the comparison.

A terminal apparatus according to the present invention is a terminal apparatus that includes a wireless communication function to directly communicate with other terminals and communication means of performing communication over a communication network with the other terminals and that can form an ad hoc network using the wireless communication function, comprising:

means of transmitting via the communication means a terminal identifier that is determined by the communication means to a communication party with which the terminal apparatus wants to form a network; means of transmitting information on the terminal identifier to the communication party by way of the wireless communication function; means of performing radio scan with the wireless communication function when a terminal identifier of the communication party is received by the communication means; means of comparing the terminal identifier of the communication party received by the communication means with the information on the terminal identifier of the communication party received in the radio scan by the wireless communication function; and means of establishing the network using the wireless communication function when a match is detected in the comparison.

Another terminal apparatus according to the present invention is a terminal apparatus that includes a wireless communication function to directly communicate with other terminals and communication means of performing communication over a communication network with the other terminals and that can form an ad hoc network using the wireless communication function, comprising:

means of transmitting via the communication means a terminal identifier that is determined by the communication means to a communication party with which the terminal apparatus wants to form a network; means of transmitting the digest of the terminal identifier to the communication party by way of the wireless communication function; means of performing radio scan with the wireless communication function when a terminal identifier of the communication party is received by the communication means; means of calculating the digest of the terminal identifier received by the communication means; means of comparing the calculated digest of the terminal identifier with the digest of the terminal identifier received in the radio scan by the wireless communication function; and means of establishing the network using the wireless communication function when a match is detected in the comparison.

An ad hoc network configuration method according to the present invention is a configuration method for an ad hoc network that is formed by a plurality of terminal apparatuses that include a wireless communication function to directly communicate with other terminals and communication means of performing communication over a communication network with the other terminals and is formed by means of the wireless communication function, wherein

a first terminal apparatus executes a process of transmitting via the communication means of the first terminal apparatus a terminal identifier that is determined by the communication means of the first terminal apparatus to a second terminal apparatus, which is a communication party with which the first terminal apparatus wants to form a network, and a process of transmitting information on the terminal identifier to the second terminal apparatus by way of the wireless communication function of the first terminal apparatus, and

the second terminal apparatus executes a process of receiving the terminal identifier with the communication means of the second terminal apparatus; a process of performing radio scan with the wireless communication function of the second terminal apparatus; a process of comparing the terminal identifier received by the communication means of the second terminal apparatus with the information on the terminal identifier received in the radio scan by the wireless communication function of the second terminal apparatus; and a process of establishing the network using the wireless communication function when a match is detected in the comparison.

Another ad hoc network configuration method according to the present invention is a configuration method for an ad hoc network that is formed by a plurality of terminal apparatuses that include a wireless communication function to directly communicate with other terminals and communication means of performing communication over a communication network with the other terminals and is formed by means of the wireless communication function, wherein

a first terminal apparatus executes a process of transmitting via the communication means of the first terminal apparatus a terminal identifier that is determined by the communication means of the first terminal apparatus to a second terminal apparatus, which is a communication party with which the first terminal apparatus wants to form a network, and a process of transmitting the digest of the terminal identifier to the second terminal apparatus by way of the wireless communication function of the first terminal apparatus, and

the second terminal apparatus executes a process of receiving the terminal identifier with the communication means of the second terminal apparatus; a process of performing radio scan with the wireless communication function of the second terminal apparatus; a process of calculating the digest of the terminal identifier received by the communication means of the second terminal apparatus; a process of comparing the calculated digest of the terminal identifier with the digest of the terminal identifier received in the radio scan by the wireless communication function of the second terminal apparatus; and a process of establishing the network using the wireless communication function when a match is detected in the comparison.

A program for an ad hoc network configuration method according to the present invention is a program for an ad hoc network configuration method for use in a terminal apparatus that includes a wireless communication function to directly communicate with other terminals and communication means of performing communication over a communication network with the other terminals and that can form an ad hoc network using the wireless communication function, causing a computer to execute

a process of transmitting via the communication means a terminal identifier that is determined by the communication means to a communication party with which the terminal apparatus wants to form a network; a process of transmitting information on the terminal identifier to the communication party by way of the wireless communication function; a process of performing radio scan with the wireless communication function when a terminal identifier of the communication party is received by the communication means; a process of comparing a terminal identifier of the communication party received by the communication means with the information on a terminal identifier of the communication party received in the radio scan by the wireless communication function; and a process of establishing the network using the wireless communication function when a match is detected in the comparison.

Another program for an ad hoc network configuration method according to the present invention is a program for an ad hoc network configuration method for use in a terminal apparatus that includes a wireless communication function to directly communicate with other terminals and communication means of performing communication over a communication network with the other terminals and that can form an ad hoc network using the wireless communication function, causing a computer to execute

a process of transmitting via the communication means a terminal identifier that is determined by the communication means to a communication party with which the terminal apparatus wants to form a network; a process of transmitting the digest of the terminal identifier to the communication party by way of the wireless communication function; a process of performing radio scan with the wireless communication function when a terminal identifier of the communication party is received by the communication means; a process of calculating the digest of the terminal identifier received by the communication means; a process of comparing the calculated digest of the terminal identifier with the digest of the terminal identifier received in the radio scan by the wireless communication function; and a process of establishing the network using the wireless communication function when a match is detected in the comparison.

Thus, the ad hoc network of the present invention facilitates establishment of a secure ad hoc network by utilizing existing communication means that is based on, e.g., a cellular or public network (i.e., a fixed telephone network). Here, an ad hoc network refers to a network that is not established in advance but formed only when actual communication is performed.

In the ad hoc network according to the present invention, when a telephone call is started or an electronic mail is transmitted, a terminal identifier of a calling terminal, e.g., a telephone number or an e-mail address, or its message digest is informed even in short-distance wireless communication (i.e., direct communication between terminals) such as a wireless Local Area Network (LAN), Bluetooth, or communication between Personal Handy-phone System (PHS) handsets.

A receiving terminal performs radio scan for short-distance wireless communication in response to an incoming call signal to determine if the calling terminal is within an ad hoc communication range in which ad hoc communication by short-distance wireless communication is available. If the calling terminal is within the ad hoc communication range and the receiving terminal permits its participation in ad hoc communication, the receiving terminal sends ad hoc communication settings to the calling terminal by way of the existing communication means.

Further, by using a terminal identifier of the existing communication means as a condition for redistributing ad hoc communication settings, the ad hoc network of the present invention also enables transfer (or introduction) of a user who wants to participate in ad hoc communication to a terminal capable of redistributing setting information by way of a transfer function of the existing communication means.

Consequently, according to the ad hoc network of the present invention, an ad hoc network can be established through operation of existing communication means such as telephone calling or electronic mail, so that a user does not have to newly learn many operations and can establish an ad hoc network with operations that can be intuitively understood by the user.

In addition, in the ad hoc network according to the present invention, because security measures against spoofing, which refers to someone masquerading as a caller, are implemented or easy to implement in the existing communication means, users can enjoy their advantages when establishing an ad hoc network as well.

Further, in the ad hoc network according to the present invention, since the existing communication means has a transfer function, e.g., a function to transfer an incoming call/telephone call in the case of a telephone call and/or transfer an electronic mail in the case of e-mail, the function can be utilized to transfer (or entrust) a request for participation in an ad hoc network to an administrator's terminal.

### BRIEF DESCRIPTION OF THE DRAWINGS

FIG. 1 is a block diagram illustrating an ad hoc network configuration method according to a first embodiment of the present invention;

FIG. 2 is a block diagram showing the configuration of an ad hoc network according to a second embodiment of the present invention;

FIG. 3 is a sequence chart illustrating the operation of ad hoc communication setting between portable terminals according to the second embodiment of the present invention;

FIG. 4 is a sequence chart illustrating the operation of ad hoc communication setting between portable terminals according to the second embodiment of the present invention;

FIG. 5 is a flowchart illustrating a telephone number reception process on a portable terminal of FIG. 2;

FIG. 6 is a flowchart illustrating a message digest reception process on a portable terminal of FIG. 2;

FIG. 7 is a flowchart illustrating an ad hoc communication start process in the second embodiment of the present invention;

FIG. 8 shows an example of wireless LAN settings stored in the ad hoc communication setting storage section of FIG. 1;

FIGS. 9A and 9B show examples of screen display on the output section of FIG. 2;

FIG. 10 is a block diagram showing the configuration of an ad hoc network according to a third embodiment of the present invention;

FIG. 11 is a flowchart illustrating a telephone number reception process on a portable terminal of FIG. 10;

FIG. 12 is a flowchart illustrating a message digest reception process on a portable terminal of FIG. 10;

FIG. 13 is a flowchart illustrating an ad hoc communication start process in the third embodiment of the present invention;

FIG. 14 shows an example of terminal identifiers stored in the terminal identifier storage section of FIG. 10;

FIG. 15 illustrates an example of screen display on the output section of FIG. 10; and

FIG. 16 illustrates an example of terminal identifiers stored in the terminal identifier storage section according to a fifth embodiment of the present invention.

### DETAILED DESCRIPTION OF THE PREFERRED EMBODIMENTS

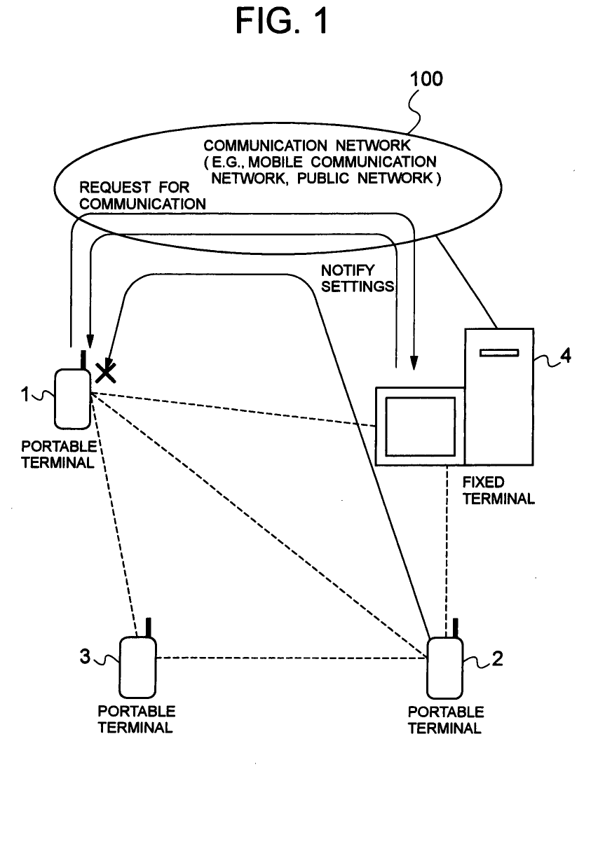

Embodiments of the present invention will be now described with reference to the drawings. FIG. 1 is a block diagram illustrating an ad hoc network configuration method according to a first embodiment of the present invention. In FIG. 1, an ad hoc network according the first embodiment of the present invention can be established by portable terminals 1 through 3 and a fixed terminal 4 that have communication means of performing communication over a communication network 100, e.g., a cellular communication network (or a mobile communication network) and a public network (or a fixed telephone network), as well as a communication function for performing short-distance wireless communication (i.e., direct communication between terminals) such as a wireless Local Area Network (LAN), Bluetooth, and communication between Personal Handy-phone System (PHS) handsets.

In the ad hoc network according to the first embodiment of the present invention, when communication by means of existing communication means is started, e.g., when a telephone call is started or an e-mail is transmitted, the terminal identifier of a calling portable terminal 1, such as a telephone number or an electronic mail address, or its message digest is informed even in short-distance wireless communication.

The receiving fixed terminal 4 performs radio scan for short-distance wireless communication in response to an incoming call signal to determine if the calling portable terminal 1 is within an ad hoc communication range in which ad hoc communication by short-distance wireless communication is available. If the calling portable terminal 1 is in the ad hoc communication range and the receiving fixed terminal 4 permits its participation in ad hoc communication, the receiving fixed terminal 4 sends ad hoc communication settings to the calling portable terminal 1 by way of the existing communication means described above.

Further, between the calling portable terminal 1 and the receiving fixed terminal 4, by using the terminal identifier of the existing communication means as a condition for redistributing ad hoc communication settings, it is possible to introduce a user who wants to participate in ad hoc communication to a fixed terminal 4, which is capable of redistributing setting information, through transfer function of the existing communication means.

In FIG. 1, the portable terminal 2 requests of the portable terminal 1 participation in an ad hoc network through its existing communication means, but the request for participation in the ad hoc network is ignored because the portable terminal 2 does not satisfy redistribution conditions (e.g., the terminal identifier of the portable terminal 2 is not registered to the portable terminal 1). In this case, if the portable terminal 2 satisfies the redistribution conditions, the portable terminal 1 may transfer the participation request from the portable terminal 2 to the fixed terminal 4, which is capable of redistributing setting information, to introduce the portable terminal 2 to the fixed terminal 4. Alternatively, the portable terminals 1 through 3 may be terminals capable of redistributing setting information.

Consequently, an ad hoc network can be established through operation of the existing communication means such as telephone calling and electronic mail of the calling portable terminal 1 and the receiving fixed terminal 4. Thus, the users of the calling portable terminal 1 and the receiving fixed terminal 4 do not have to learn many new operations and can establish an ad hoc network through operations that can be intuitively understood by the users.

In addition, because security measures against spoofing, which refers to someone masquerading as a caller, are implemented or easy to implement in the existing communication means of the calling portable terminal 1 and the receiving fixed terminal 4, users can enjoy their advantages when establishing an ad hoc network as well.

Furthermore, since the calling portable terminal 1 and the receiving fixed terminal 4 have transfer function in their existing communication means, e.g., a function to transfer an incoming call/telephone call in the case of a telephone call and/or transfer an electronic mail in the case of e-mail, the function can be utilized to entrust a request for participation in an ad hoc network to an administrator's portable terminal.

The existing communication means may be applications for telephone calling and/or electronic mail, but may also be instant messaging and/or Push-to-Talk, for example, as long as it can transmit/receive terminal identifiers and implement security measures.

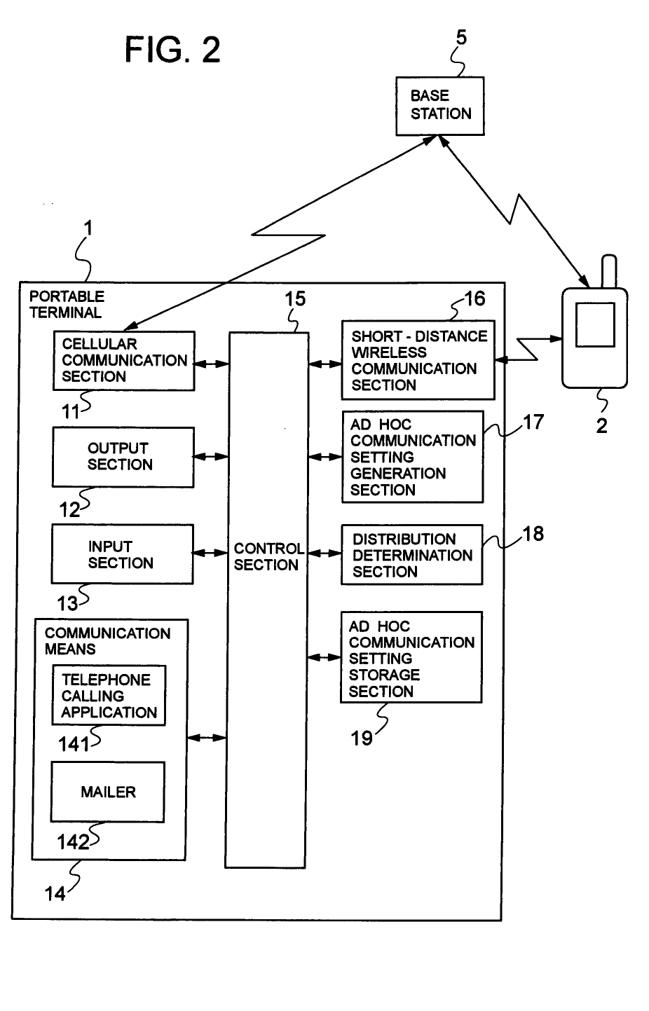

FIG. 2 shows a block diagram illustrating the configuration of an ad hoc network according to a second embodiment of the present invention. In FIG. 2, the ad hoc network according to the second embodiment of the present invention is formed of two or more portable terminals 1 and 2 that are capable of both cellular communication and short-distance wireless communication and a base station 5 for cellular communication performed by the portable terminals 1 and 2.

The portable terminal 1 includes a cellular communication section 11, an output section 12, an input section 13, a communication means 14, a control section 15, a short-distance wireless communication section 16, an ad hoc communication setting generation section 17, a distribution determination section 18, and an ad hoc communication setting storage section 19. Although not shown, the portable terminal 2 of FIG. 2 has a similar configuration to the portable terminal 1 and operations of its internal components are denoted with similar reference numerals as the portable terminal 1.

The cellular communication section 11 realizes communication with the base station 5 for a portable telephone network by means of a wireless communication scheme such as Code Division Multiple Access (CDMA) and Personal Digital Cellular (PDC).

The short-distance wireless communication section 16 realizes ad hoc network communication by means of a wireless LAN that complies with standards of IEEE (Institute of Electrical and Electronic Engineers) 802.11 and/or Bluetooth.

The output section 12 may be a liquid crystal display or a speaker for realizing output to the user. The input section 13 may be a button or a microphone for realizing input from the user. The communication means 14 is existing communication means such as a telephone calling application 141 and an e-mail application (hereinafter a “mailer”) 142, realizing communication among users.

The ad hoc communication setting generation section 17 generates setting information for establishing a secure ad hoc network. The ad hoc communication setting storage section 19 stores ad hoc communication settings generated by the ad hoc communication setting generation section 17 or distributed by another portable terminal 2. The distribution determination section 18 controls ad hoc communication settings which are distributed to another portable terminal 2.

For an ad hoc network based on a wireless LAN, setting information for establishing an ad hoc network may be an Extended Service Set ID (ESSID), a Wired Equivalent Privacy (WEP) key (40-bit or 104-bit), an authentication method (open authentication or shared authentication), a channel (Channels 1 to 14 in Japan), and the identifier of an activated application (an application used in an ad hoc network, e.g., a business card exchange or battle game application), an application itself, or a destination of a downloaded application (a URL:Uniform Resource Locator). For the channel information, a fixed channel may be notified as setting information or variable channel information may be notified without specifying a particular channel.

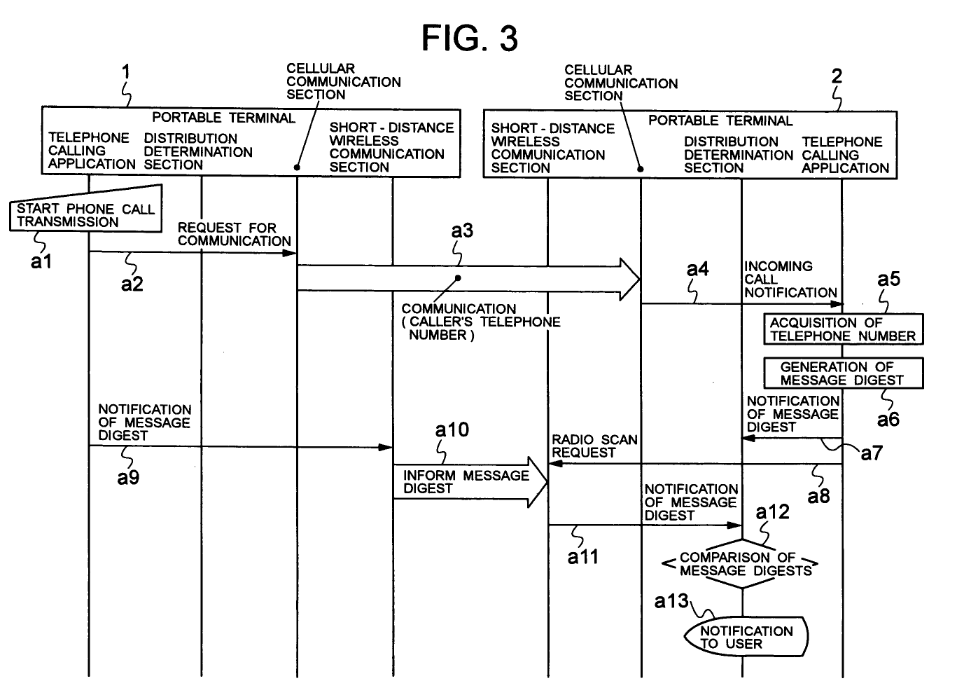

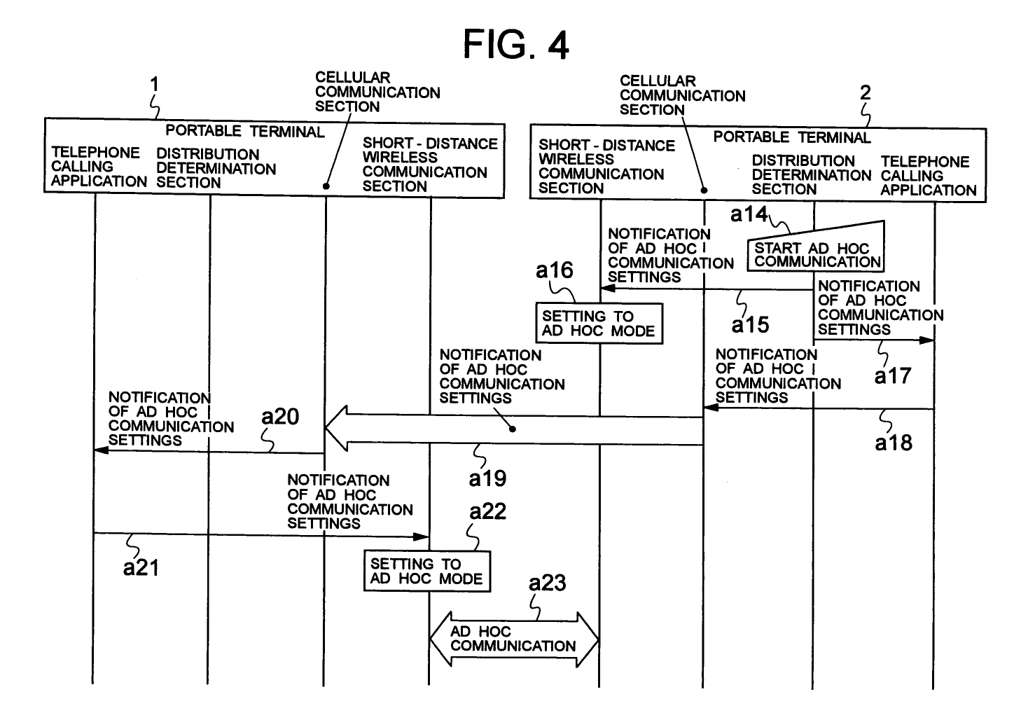

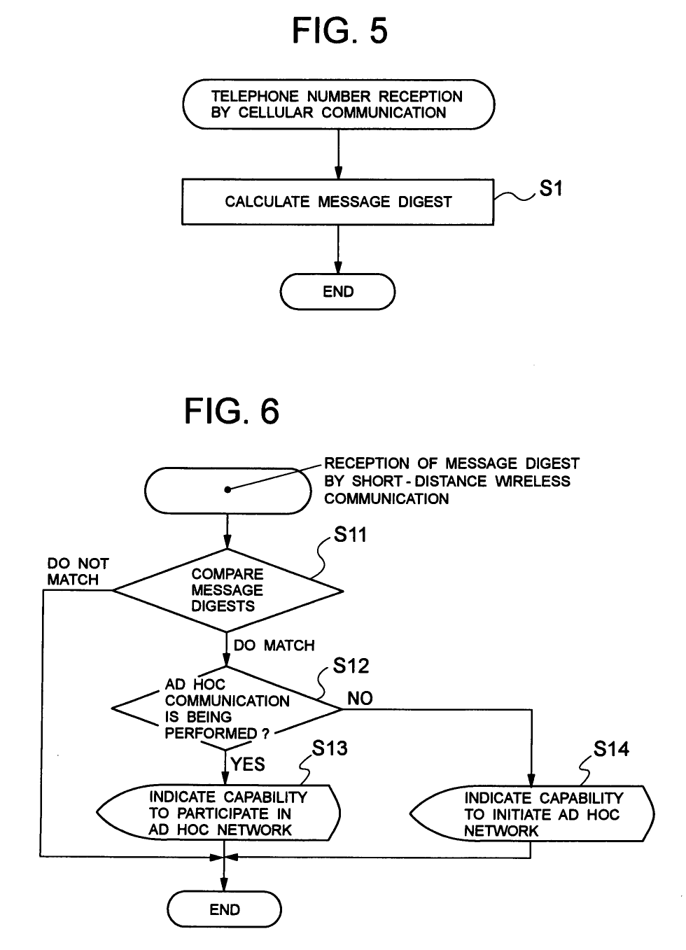

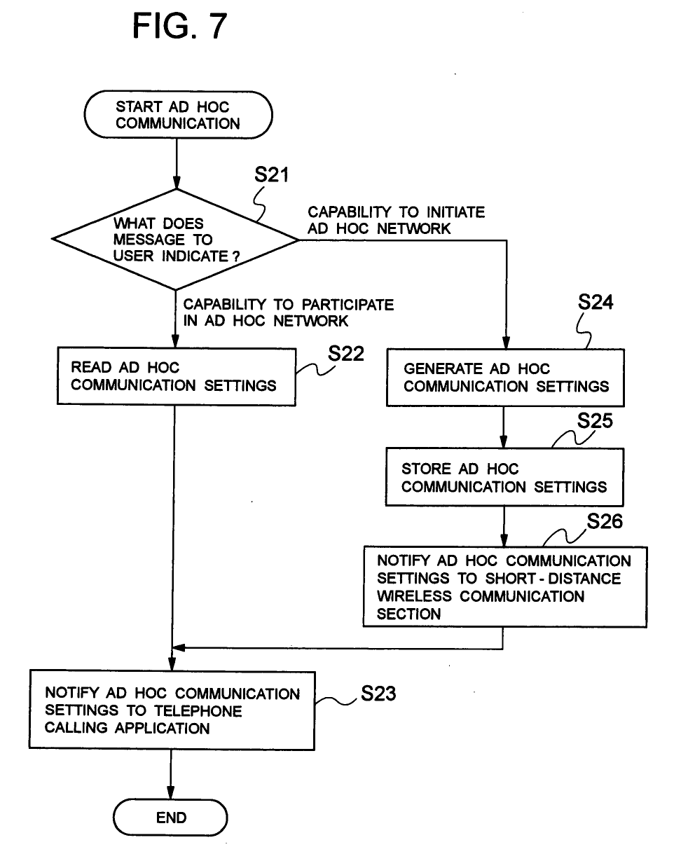

FIGS. 3 and 4 show sequence charts that illustrate operations of ad hoc communication setting between the portable terminals 1 and 2 in the second embodiment of the present invention; FIG. 5 is a flowchart showing a telephone number receiving process on the portable terminal 1 shown in FIG. 2; FIG. 6 is a flowchart showing a message digest receiving process on the portable terminal 1 shown in FIG. 2; and FIG. 7 is a flowchart showing an ad hoc communication start process according to the second embodiment of the present invention.

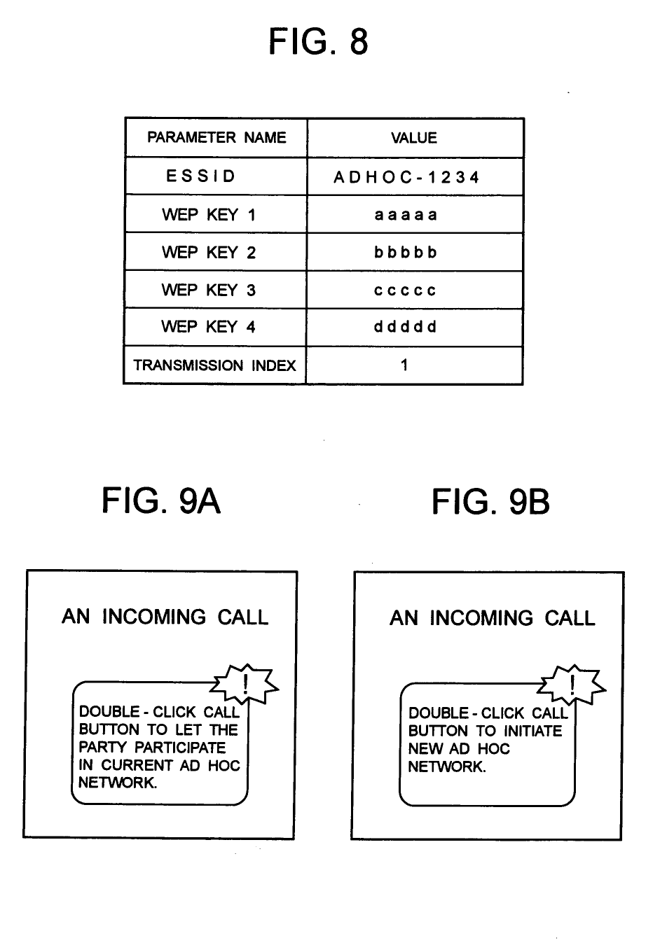

FIG. 8 shows an example of wireless LAN settings stored in the ad hoc communication setting storage section 19 of FIG. 2; and FIGS. 9A and 9B show examples of screen display on the output section 12 of FIG. 2. In FIG. 8, parameter names (“ESSID”, “WEP key 1”, “WEP key 2”, “WEP key 3”, “WEP key 4” and “transmission index”) and their values (“AD HOC-1234”, “aaaaa”, “bbbbb”, “ccccc”, “ddddd”, and “1”) are stored in the ad hoc communication setting storage section 19. FIG. 9A shows indication of the capability to participate in ad hoc network on the output section 12 and FIG. 9B shows indication of the capability to initiate ad hoc network on the output section 12.

With reference to FIGS. 2 to 9, description will be given of an operation of establishing an ad hoc network according to the second embodiment of the present invention. The description of the operation assumes that the communication means 14 is the telephone calling application 141 that performs voice calls, which is a basic function of a portable telephone, and the communication scheme used by the short-distance wireless communication section 16 is wireless LAN. When the communication means 14, short-distance wireless communication section 16, ad hoc communication setting generation section 17, and distribution determination section 18 of the portable terminal 1 are realized through execution of programs at the control section 15, the operations shown in FIGS. 5 to 7 can also be realized by the control section 15 executing the programs.

When the user who wants to start ad hoc communication transmits a call to the portable terminal 2 of the party with whom the user wants to establish an ad hoc network through the telephone calling application 141 (call transmission start) (see al in FIG. 3), the telephone calling application 141 sends a communication request to the cellular communication section 11 (see a2 in FIG. 3), and the cellular communication section 11 performs communication with the cellular communication section 11 of the portable terminal 2 (see a3 in FIG. 3).

Simultaneously with the transmission of cellular communication, the portable terminal 1 calculates the message digest of its own telephone number and informs it to the short-distance wireless communication section 16 (notification of a message digest) (see a9 in FIG. 3). A message digest is a value which is calculated by a special algorithm and the value of a message digest varies with original data, characterized in that it is difficult to estimate the original data from it.

Thus, by informing a message digest rather than directly notifying a telephone number or an e-mail address, it is made difficult to steal a telephone number or e-mail address, which is personal information. The special algorithm may be Message Digest Algorithm 5(MD5) that is published in Request For Comments (RFC) 1320 or Secure Hash Algorithm 1(SHA1) which is adopted as the standard for the U.S. government.

The short-distance wireless communication section 16 informs the message digest of the telephone number (see a10 in FIG. 3). Notification of a message digest by the short-distance wireless communication section 16 can be realized by performing active scanning with the message digest as the value of an ESSID when the wireless scheme is a wireless LAN, but this is not limitation. The following description will assume that a message digest itself is informed, not limited to the value of an ESSID.

Subsequently, when the telephone calling application 141 of the receiving portable terminal 2 receives notification of an incoming call from the cellular communication section 11 (incoming call notification) (see a4 in FIG. 3), it obtains the telephone number of the caller (acquisition of a telephone number) (see a5 in FIG. 3), and calculates the message digest of the telephone number (see a6 in FIG. 3). If a service for transmitting the telephone number of the caller when a call is started (i.e., a caller ID notification service) is not implemented, the receiving portable terminal 2 cannot obtain the caller's telephone number. In that case, only call processing is continued by the telephone calling application 141.

The telephone calling application 141 then notifies the calculated message digest to the distribution determination section 18 (notification of a message digest) (see a7 in FIG. 3) and also requests the short-distance wireless communication section 16 to perform radio scan (radio scan request) (see a8 in FIG. 3).

If radio scan by the short-distance wireless communication section 16 shows that the calling portable terminal 1 is within the short-distance communication range, the message digest of the telephone number which is being informed by the calling portable terminal 1 can be received. When the short-distance wireless communication section 16 successfully receives the message digest of the telephone number, it sends the message digest to the distribution determination section 18 (notification of a message digest) (see a11 in FIG. 3).

The distribution determination section 18 of the receiving portable terminal 2 compares the message digest calculated by the telephone calling application 141 from the received telephone number with the one received from the short-distance wireless communication section 16 (comparison of message digests) (see a12 in FIG. 3). Then, if the values of the message digests match, the distribution determination section 18 informs the user through the output section 12 such as a liquid crystal display that the calling portable terminal 1 is capable of ad hoc communication (notification to the user) (see a13 in FIG. 3). Examples of screen display on the portable terminal 2 at this point are shown in FIGS. 9A and 9B.

When the user performs an operation which is assigned to start of ad hoc communication on the receiving portable terminal 2 (ad hoc communication start) (see a14 in FIG. 4), the distribution determination section 18 sends setting information for ad hoc communication such as an ESSID and a WEP key generated by the ad hoc communication setting generation section 17 to the short-distance wireless communication section 16 (notification of ad hoc communication settings) (see a15 in FIG. 4), thereby setting the short-distance wireless communication section 16 to an ad hoc mode (setting to ad hoc mode) (see a16 in FIG. 4). The operation assigned to start of ad hoc communication can be realized by pressing a call start button twice successively at a short interval (referred to as “double clicking” for a personal computer), for example.

Further, the distribution determination section 18 also sends the ad hoc communication settings to the telephone calling application 141 (notification of ad hoc communication settings) (see a17 in FIG. 4). The telephone calling application 141 sends the ad hoc communication settings to the calling portable terminal 1 utilizing the communication means (i.e., the cellular communication section 11) of the telephone calling application 141 (notification of ad hoc communication settings) (see a18 and a19 in FIG. 4).

If a communication protocol used by the telephone calling application 141 of the portable terminal 2 is Session Initiation Protocol (SIP), which is published as an RFC, it is possible to handle the protocol for transmitting ad hoc communication settings as a new medium and send the ad hoc communication settings as one medium after exchange of media capability by way of Session Description Protocol (SDP). Alternatively, data on ad hoc communication settings may be modulated and transmitted as audio data as in conventional data communication based on modems in a circuit switching network.

Finally, when the telephone calling application 141 of the calling portable terminal 1 receives the ad hoc communication settings via the cellular communication section 11 (notification of ad hoc communication settings) (see a19 and a20 in FIG. 4), the telephone calling application 141 stores the ad hoc communication settings in the ad hoc communication setting storage section 19 and also sends it to the short-distance wireless communication section 16 (notification of ad hoc communication settings) (see a21 in FIG. 4) to set the short-distance wireless communication section 16 to the ad hoc mode (setting to ad hoc mode) (see a22 in FIG. 4).

The short-distance wireless communication section 16 of both the calling and receiving portable terminals 1 and 2 is set to the ad hoc mode through the operations described above, so that a secure ad hoc network can be easily established between the calling portable terminal 1 and the receiving portable terminal 2 (ad hoc communication) (see a23 in FIG. 4).

Now, the operation of the distribution determination section 18 will be described with reference to FIGS. 5 through 7. Flows shown in FIGS. 5 and 6 illustrate operations up to comparison of message digests and display of a message to the user; and the flow shown in FIG. 7 illustrates operations after receiving the user's instruction to start ad hoc communication.

When the telephone calling application 141 obtains a telephone number from notification of an incoming call via the cellular communication section 11, it calculates and holds a message digest (step S1 in FIG. 5). On the other hand, when the distribution determination section 18 receives a message digest from the short-distance wireless communication section 16, it compares the message digest with the one previously calculated by the telephone calling application 141 (step S11 in FIG. 6). If the message digests do not match, the distribution determination section 18 determines that the calling portable terminal 1 is not within the ad hoc communication range and continues to perform normal call processing.

However, if the message digests match and if ad hoc communication is already being performed with a party other than the calling portable terminal 1 (step S12 in FIG. 6), the distribution determination section 18 displays a message indicating that the portable terminal 1 can participate in the current ad hoc network on the liquid crystal display as the output section 12 (indication of the capability to participate in ad hoc network) (step S13 in FIG. 6). FIG. 9A shows an example of the screen message displayed on the portable terminal.

If ad hoc communication is not being performed (step S12 in FIG. 6), the distribution determination section 18 displays a message indicating that a new ad hoc network can be initiated on the liquid crystal display as the output section 12 (indication of the capability to initiate ad hoc network) (step S14 in FIG. 6). FIG. 9B shows an example of the screen message displayed on the portable terminal.

Then, when the user gives an instruction to start ad hoc communication, if the message to the user indicates the capability to participate in ad hoc network (step S21 in FIG. 7), the distribution determination section 18 reads setting information from the ad hoc communication setting storage section 19 (read-out of ad hoc communication settings) (step S22 in FIG. 7), and notifies the ad hoc communication settings to the telephone calling application 141 (notification of ad hoc communication settings to the telephone calling application) (step S23 in FIG. 7).

If the message to the user indicates the capability to initiate ad hoc communication (step S21 in FIG. 7), the distribution determination section 18 stores the setting information generated by the ad hoc setting generation section 17 in the ad hoc communication setting storage section 19 (steps S24 and S25 in FIG. 7), and sends the ad hoc communication settings to the short-distance wireless communication section 16 and the telephone calling application 141 (steps S26 and S23 in FIG. 7).

Through the above-described operations, an ad hoc network can be established among three or more portable terminals with simple operations as in the case of an ad hoc network between two terminals illustrated above. Although this embodiment describes establishment of an ad hoc network between the portable terminals 1 and 2, this is also applicable to establishment of an ad hoc network that involves a fixed terminal as in the first embodiment of the present invention described earlier or to establishment of an ad hoc network between fixed terminals.

As illustrated above, since this embodiment enables establishment of an ad hoc network through operation of the existing communication means 14 such as telephone calling or electronic mail, the user does not have to newly learn many operations when establishing an ad hoc network, which facilitates intuitive understanding by the user.

Also, in this embodiment, since security measures against spoofing, which refers to someone masquerading as a caller, are already implemented or easy to implement in the existing communication means 14, the user can enjoy their advantages also in establishment of an ad hoc network.

Further, in this embodiment, since the existing communication means 14 has a transfer function, e.g., a function to transfer an incoming call/telephone call in the case of telephone calling and/or to transfer an electronic mail in the case of e-mail, the function can be utilized to entrust a request for participation in an ad hoc network to an administrator's portable terminal.

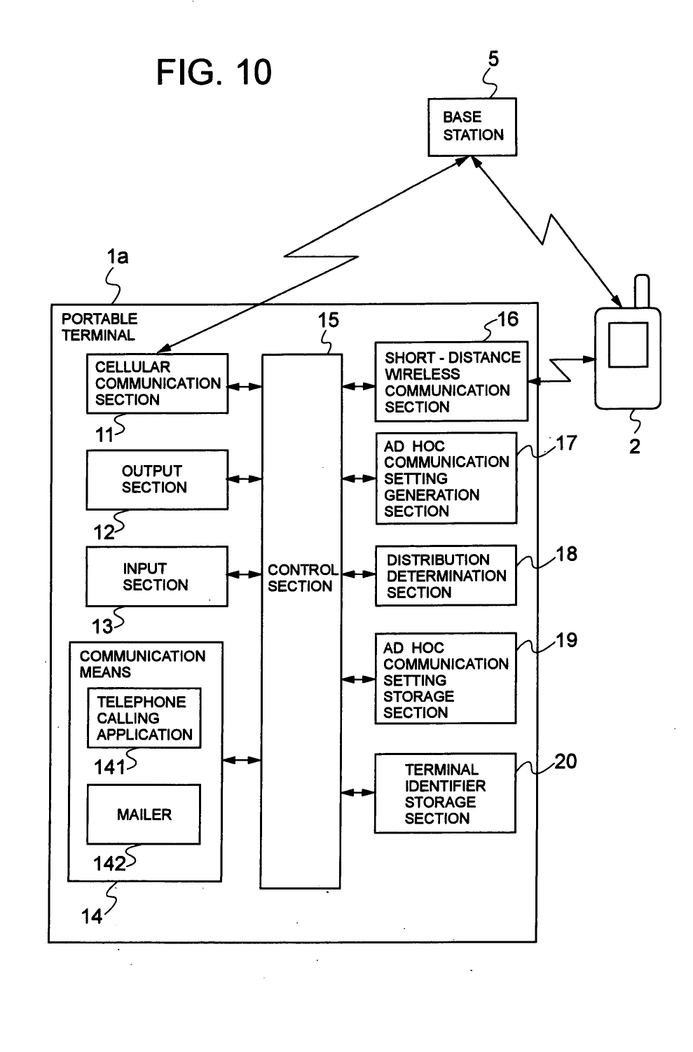

FIG. 10 shows a block diagram illustrating the configuration of an ad hoc network according to a third embodiment of the present invention. In FIG. 10, the ad hoc network according to the third embodiment of the present invention has a similar configuration to the ad hoc network of the second embodiment of the present invention shown in FIG. 2 except that a terminal identifier storage section 20 is added to the portable terminal la, and the same components are denoted with the same reference numerals. The operations of the same components are similar to those of the second embodiment of the present invention.

The terminal identifier storage section 20 is used for storing one or more terminal identifiers of portable terminals that are authorized to distribute ad hoc communication settings when redistribution of ad hoc communication settings should be limited. When the terminal identifier storage section 20 is empty, operations may be similar to the second embodiment of the present invention described above or redistribution may not be permitted at all. In this embodiment, when the terminal identifier storage section 20 is empty, redistribution is permitted to everyone as in the second embodiment of the present invention described above.

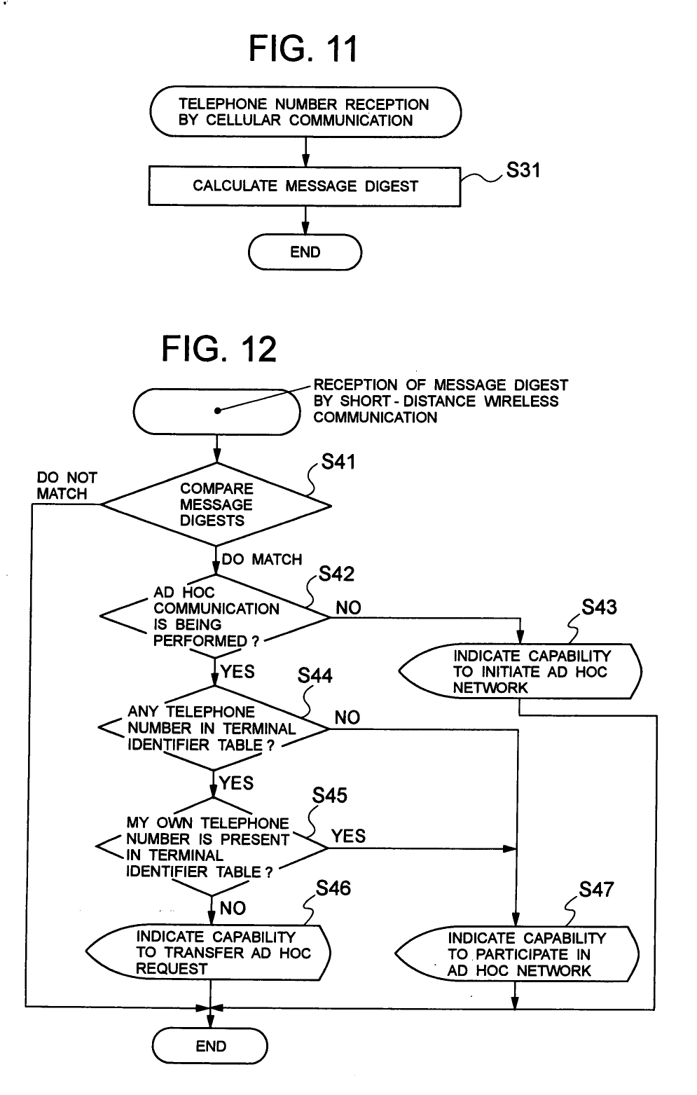

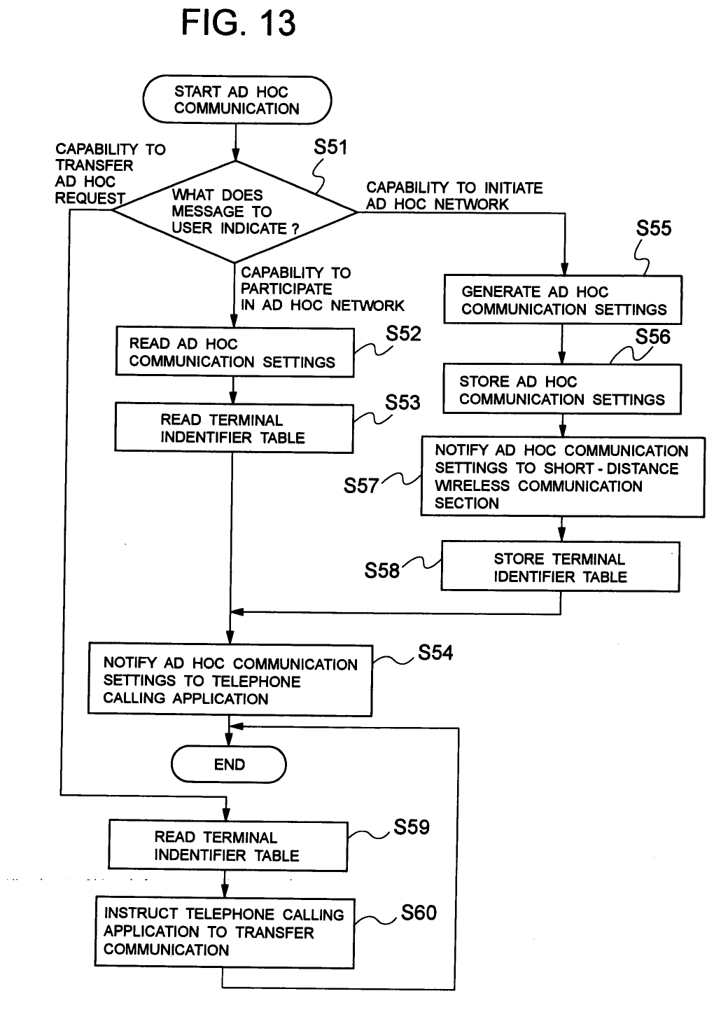

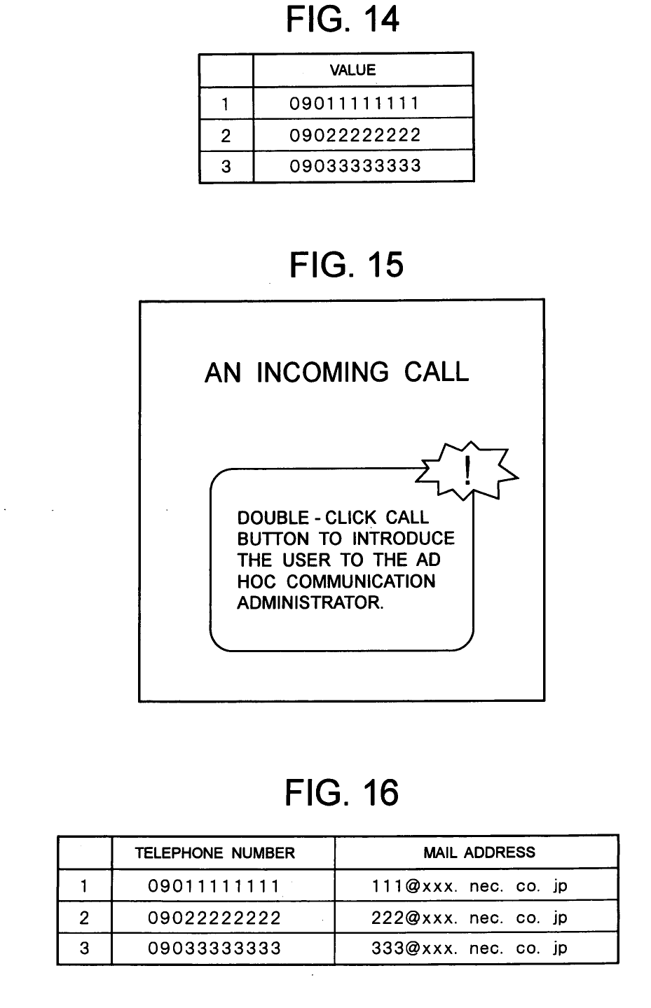

FIG. 11 is a flowchart illustrating a telephone number receiving process by the portable terminal 1a of FIG. 10; FIG. 12 is a flowchart illustrating a message digest receiving process by the portable terminal 1a of FIG. 10; and FIG. 13 is a flowchart illustrating an ad hoc communication start process in the third embodiment of the present invention. FIG. 14 shows an example of terminal identifiers stored in the terminal identifier storage section 20 of FIG. 10, and FIG. 15 shows an example of screen display on the output section 12 of FIG. 10.

In FIG. 14, values of terminal identifiers (“09011111111”, “09022222222”, and “09033333333”) are stored in the terminal identifier storage section 20. With reference to FIGS. 10 to 15, establishment of an ad hoc network according to the third embodiment of the present invention will be described. When the communication means 14, short-distance wireless communication section 16, ad hoc communication setting generation section 17, and distribution determination section 18 of the portable terminal la are realized through execution of programs at the control section 15, the operations shown in FIGS. 11 to 13 can also be realized by the control section 15 executing the programs.

When the telephone calling application 141 obtains a telephone number from notification of an incoming call from the cellular communication section 11, it calculates and holds a message digest (step S31 in FIG. 11). Meanwhile, when the distribution determination section 18 receives a message digest from the short-distance wireless communication section 16, it compares the message digest with the one previously calculated by the telephone calling application 141 (step S41 in FIG. 12). If the message digests do not match, the distribution determination section 18 determines that the calling portable terminal (portable terminal 2) is not within the ad hoc communication range and continues to perform normal call processing with the telephone calling application 141.

However, if the message digests do match and if ad hoc communication is not being performed (step S42 in FIG. 12), the distribution determination section 18 displays a message indicating that a new ad hoc network can be initiated on the liquid crystal display as the output section 12 (indication of the capability to initiate ad hoc network) (step S43 in FIG. 12).

If ad hoc communication is already being performed (step S42 in FIG. 12), the distribution determination section 18 checks whether there is any telephone number in the terminal identifier table of the terminal identifier storage section 20 (step S44 in FIG. 12). If there is no telephone number in the table, it displays a message indicating that the calling portable terminal 2 can participate in the current ad hoc network on the liquid crystal display (step S47 in FIG. 12).

If there is any telephone number in the terminal identifier storage section 20, the distribution determination section 18 checks whether the telephone number of the portable terminal 1a is present in the terminal identifier table of the terminal identifier storage section 20 (step S45 in FIG. 12). If the telephone number of the portable terminal la is present in the terminal identifier table of the terminal identifier storage section 20, the distribution determination section 18 displays a message indicating that the calling portable terminal 2 can participate in the current ad hoc network on the liquid crystal display (step S47 in FIG. 12).

If the telephone number of the portable terminal 1a is not present in the terminal identifier table of the terminal identifier storage section 20, the distribution determination section 18 displays a message on the liquid crystal display indicating that the request for participation in the ad hoc network can be transferred (step S46 in FIG. 12). An example of the screen message displayed on the portable terminal 1a at this point is shown in FIG. 15.

Here, presence of the telephone number of the portable terminal 1a in the terminal identifier table of the terminal identifier storage section 20 means that the portable terminal 1a is authorized to redistribute ad hoc communication settings.

Subsequently, when the user gives an instruction to start ad hoc communication, if the message to the user described above indicates the capability to initiate ad hoc network (step S51 in FIG. 13), the distribution determination section 18 stores setting information generated by the ad hoc setting generation section 17 in the ad hoc communication setting storage section 19 (steps S55 and S56 in FIG. 13), and sends the ad hoc communication settings to the short-distance wireless communication section 16 (step S57 in FIG. 13). The distribution determination section 18 further registers a rule for redistributing the newly generated ad hoc communication settings to the terminal identifier table of the terminal identifier storage section 20 (step S58 in FIG. 13).

Specifically, when redistribution of ad hoc communication settings is to be permitted to all portable terminals that participate in an ad hoc network, the terminal identifier table of the terminal identifier storage section 20 is left empty. On the other hand, when redistribution of ad hoc communication settings should be limited to certain portable terminals, terminal identifiers of portable terminals to which authority for redistribution is granted, e.g., one ore more telephone numbers, are stored in the terminal identifier table of the terminal identifier storage section 20. Then, the distribution determination section 18 notifies the ad hoc communication settings as well as the contents of the terminal identifier table of the terminal identifier storage section 20 to the telephone calling application 141 (step S54 in FIG. 13).

Which portable terminal should be authorized to redistribute ad hoc communication settings may be determined by the user with a button when establishing a new ad hoc network or a terminal identifier may be automatically registered from an address book.

Upon receiving the ad hoc communication settings and the contents of the terminal identifier table of the terminal identifier storage section 20, the telephone calling application 141 sends the two pieces of information to the calling portable terminal 2.

Then, if the message to the user indicates the capability to participate in ad hoc network (step S51 in FIG. 13), the distribution determination section 18 reads ad hoc communication settings from the ad hoc communication setting storage section 19 (step S52 in FIG. 13), reads in the terminal identifier table from the terminal identifier storage section 20 (step S53 in FIG. 13), and notifies the ad hoc communication settings and the contents of the terminal identifier table to the telephone calling application 141 (step S54 in FIG. 13).

Finally, if the message to the user indicates the capability to transfer an ad hoc request (step S51 in FIG. 13), the distribution determination section 18 reads the terminal identifier table from the terminal identifier storage section 20 (step S59 in FIG. 13), and instructs the telephone calling application 141 to transfer the incoming call (request for participation in the ad hoc network) to a portable terminal having the terminal identifier in the table (step S60 in FIG. 13).

If a plurality of terminal identifiers are registered in the terminal identifier table of the terminal identifier storage section 20, the user may be allowed to select an identifier as destination of transfer, or the first one of the terminal identifiers registered in the terminal identifier table may be automatically selected preferentially.

Through the operations described above, this embodiment can control participants in an ad hoc network using the terminal identifier of the existing communication means 14 based on registration to the terminal identifier table of the terminal identifier storage section 20.

In a fourth embodiment of the present invention, the mailer 142 can be utilized as the communication means 14 instead of the telephone calling application 141. In this case, an electronic mail address serves as a terminal identifier and the mailer of a receiving portable terminal will send the e-mail address in “From” to the distribution determination section 18 of the receiving portable terminal.

When the mailer 142 is used as the communication means 14, a caller's operations are not always notified to the receiver instantaneously as with the telephone calling application 141. The mailer 142 of the receiving portable terminal is therefore required to calculate the difference in time between the time of transmitting an e-mail which stored in the header of the e-mail and the reception time of receiving the e-mail and not to perform distribution of ad hoc communication settings when the calculated difference is equal to or longer than a predetermined time period.

In a fifth embodiment of the present invention, the telephone calling application 141 and the mailer 142 are employed concurrently to establish an ad hoc network with the configuration of the second embodiment of the present invention described above.

In this case, terminal identifiers of the telephone calling application 141 and the mailer 142 may be stored in the terminal identifier storage section 20 of the third embodiment of the present invention to control participation in an ad hoc network. An example of storage in the terminal identifier storage section 20 is shown in FIG. 16 for a case where two or more communication means are used in this way.

In FIG. 16, as values of terminal identifiers, telephone numbers (“09011111111”, “09022222222”, and “09033333333”) and electronic mail addresses (“111@xxx.nec.co.jp”, “222@xxx.nec.co.jp”, and “333@xxx.nec.co.jp”) are stored in the terminal identifier storage section 20 respectively being associated with each other.

As described above, since this embodiment stores telephone numbers and e-mail addresses in the terminal identifier storage section 20 as values of terminal identifiers, a request for participation in an ad hoc network, initiation of ad hoc network, and setting information for ad hoc communication can be exchanged by e-mail when telephone calling is not available, for example.

What is claimed is:

1. An ad hoc network that is formed by a plurality of terminal apparatuses that include a wireless communication function to directly communicate with other terminals and communication means of performing communication over a communication network with the other terminals and is formed by means of the wireless communication function, wherein
a first terminal apparatus comprises means of transmitting via the communication means of the first terminal apparatus a terminal identifier that is determined by the communication means of the first terminal apparatus to a second terminal apparatus, which is a communication party with which the first terminal apparatus wants to form a network, and means of transmitting information on the terminal identifier to the second terminal apparatus by way of the wireless communication function of the first terminal apparatus, and
the second terminal apparatus comprises means of receiving the terminal identifier with the communication means of the second terminal apparatus; means of performing radio scan with the wireless communication function of the second terminal apparatus; means of comparing the terminal identifier received by the communication means of the second terminal apparatus with the information on the terminal identifier received in the radio scan by the wireless communication function of the second terminal apparatus; and means of establishing the network using the wireless communication function when a match is detected in the comparison.

2. An ad hoc network that is formed by a plurality of terminal apparatuses that include a wireless communication function to directly communicate with other terminals and communication means of performing communication over a communication network with the other terminals and is formed by means of the wireless communication function, wherein
a first terminal apparatus comprises means of transmitting via the communication means of the first terminal apparatus a terminal identifier that is determined by the communication means of the first terminal apparatus to a second terminal apparatus, which is a communication party with which the first terminal apparatus wants to form a network, and means of transmitting the digest of the terminal identifier to the second terminal apparatus by way of the wireless communication function of the first terminal apparatus, and
the second terminal apparatus comprises means of receiving the terminal identifier with the communication means of the second terminal apparatus; means of performing radio scan with the wireless communication function of the second terminal apparatus; means of calculating the digest of the terminal identifier received by the communication means of the second terminal apparatus; means of comparing the calculated digest of the terminal identifier with the digest of the terminal identifier received in the radio scan by the wireless communication function of the second terminal apparatus; and means of establishing the network using the wireless communication function when a match is detected in the comparison.

3. The ad hoc network according to claim 1, wherein the communication means performs at least either of communication based on cellular communication or communication over a fixed telephone network.

4. The ad hoc network according to claim 3, wherein the communication means includes at least either of a telephone calling application or an electronic mail application.

5. The ad hoc network according to claim 4, wherein the terminal identifier includes at least either of a telephone number or an electronic mail address.

6. The ad hoc network according to claim 1, wherein the information on the terminal identifier contains at least a message digest that is calculated from the terminal identifier by a predetermined algorithm.

7. The ad hoc network according to claim 1, wherein the second terminal apparatus transmits ad hoc communication settings to the first terminal apparatus by way of the communication means of the second terminal apparatus when establishing the network.

8. The ad hoc network according to claim 7, wherein
the second terminal apparatus comprises storage means of storing a terminal identifier table that maintains a terminal identifier, and
the terminal identifier table is included in the ad hoc communication settings in order to control redistribution of setting information.

9. The ad hoc network according to claim 1, wherein the means of establishing the network transmits ad hoc communication settings to the first terminal apparatus by way of the communication means of the second terminal apparatus to permit participation of the first terminal apparatus in the network when ad hoc communication is already being performed with a terminal apparatus other than the first terminal apparatus.

10. The ad hoc network according to claim 1, wherein a transfer function provided by the communication means is utilized to transfer a request for participation of the first terminal apparatus in the network to an administrator's terminal apparatus.

11. The ad hoc network according to claim 1, wherein the wireless communication function is a short-distance wireless communication function including at least wireless Local Area Network (LAN).

12. The ad hoc network according to claim 1, wherein the first and the second terminal apparatuses are either portable terminals including at least portable telephones and Personal Digital Assistants (PDAs) or fixed terminals including at least fixed telephones and Internet Protocol (IP) phones.

13. A terminal apparatus that includes a wireless communication function to directly communicate with other terminals and communication means of performing communication over a communication network with the other terminals and that can form an ad hoc network using the wireless communication function, comprising:
means of transmitting via the communication means a terminal identifier that is determined by the communication means to a communication party with which the terminal apparatus wants to form a network; means of transmitting information on the terminal identifier to the communication party by way of the wireless communication function; means of performing radio scan with the wireless communication function when a terminal identifier of the communication party is received by the communication means; means of comparing the terminal identifier of the communication party received by the communication means with the information on the terminal identifier of the communication party received in the radio scan by the wireless communication function; and means of establishing the network using the wireless communication function when a match is detected in the comparison.

14. A terminal apparatus that includes a wireless communication function to directly communicate with other terminals and communication means of performing communication over a communication network with the other terminals and that can form an ad hoc network using the wireless communication function, comprising:
means of transmitting via the communication means a terminal identifier that is determined by the communication means to a communication party with which the terminal apparatus wants to form a network; means of transmitting the digest of the terminal identifier to the communication party by way of the wireless communication function; means of performing radio scan with the wireless communication function when a terminal identifier of the communication party is received by the communication means; means of calculating the digest of the terminal identifier received by the communication means; means of comparing the calculated digest of the terminal identifier with the digest of the terminal identifier received in the radio scan by the wireless communication function; and means of establishing the network using the wireless communication function when a match is detected in the comparison.

15. The terminal apparatus according to claim 13, wherein the communication means performs at least either of communication based on cellular communication or communication over a fixed telephone network.

16. The terminal apparatus according to claim 15, wherein the communication means includes at least either of a telephone calling application or an electronic mail application.

17. The terminal apparatus according to claim 16, wherein the terminal identifier includes at least either of a telephone number or an electronic mail address.

18. The terminal apparatus according to claim 13, wherein the information on the terminal identifier contains at least a message digest that is calculated from the terminal identifier by a predetermined algorithm.

19. The terminal apparatus according to claim 13, wherein ad hoc communication settings are transmitted to the communication party by way of the communication means when the network is established.

20. The terminal apparatus according to claim 19, comprising
storage means of storing a terminal identifier table that maintains a terminal identifier, wherein
the terminal identifier table is included in the ad hoc communication settings in order to control redistribution of setting information.

21. The terminal apparatus according to claim 13, wherein the means of establishing the network transmits ad hoc communication settings to the communication party by way of the communication means to permit participation of the communication party in the network when ad hoc communication is already being performed with a terminal apparatus other than the communication party.

22. The terminal apparatus according to claim 13, wherein a transfer function provided by the communication means is utilized to transfer a request for participation of the communication party in the network to an administrator's terminal apparatus.

23. The terminal apparatus according to claim 13, wherein the wireless communication function is a short-distance wireless communication function including at least wireless Local Area Network (LAN).

24. The terminal apparatus according to claim 13, wherein the terminal apparatus is either a portable terminal including at least a portable telephone and a Personal Digital Assistant (PDA) or a fixed terminal including at least a fixed telephone and an Internet Protocol (IP) phone.

25. A configuration method for an ad hoc network that is formed by a plurality of terminal apparatuses that include a wireless communication function to directly communicate with other terminals and communication means of performing communication over a communication network with the other terminals and is formed by means of the wireless communication function, wherein
a first terminal apparatus executes a process of transmitting via the communication means of the first terminal apparatus a terminal identifier that is determined by the communication means of the first terminal apparatus to a second terminal apparatus, which is a communication party with which the first terminal apparatus wants to form a network, and a process of transmitting information on the terminal identifier to the second terminal apparatus by way of the wireless communication function of the first terminal apparatus, and
the second terminal apparatus executes a process of receiving the terminal identifier with the communication means of the second terminal apparatus; a process of performing radio scan with the wireless communication function of the second terminal apparatus; a process of comparing the terminal identifier received by the communication means of the second terminal apparatus with the information on the terminal identifier received in the radio scan by the wireless communication function of the second terminal apparatus; and a process of establishing the network using the wireless communication function when a match is detected in the comparison.

26. A configuration method for an ad hoc network that is formed by a plurality of terminal apparatuses that include a wireless communication function to directly communicate with other terminals and communication means of performing communication over a communication network with the other terminals and is formed by means of the wireless communication function, wherein
a first terminal apparatus executes a process of transmitting via the communication means of the first terminal apparatus a terminal identifier that is determined by the communication means of the first terminal apparatus to a second terminal apparatus, which is a communication party with which the first terminal apparatus wants to form a network, and a process of transmitting the digest of the terminal identifier to the second terminal apparatus by way of the wireless communication function of the first terminal apparatus, and
the second terminal apparatus executes a process of receiving the terminal identifier with the communication means of the second terminal apparatus; a process of performing radio scan with the wireless communication function of the second terminal apparatus; a process of calculating the digest of the terminal identifier received by the communication means of the second terminal apparatus; a process of comparing the calculated digest of the terminal identifier with the digest of the terminal identifier received in the radio scan by the wireless communication function of the second terminal apparatus; and a process of establishing the network using the wireless communication function when a match is detected in the comparison.

27. The ad hoc network configuration method according to claim 25, wherein the communication means performs at least either of communication based on cellular communication or communication over a fixed telephone network.

28. The ad hoc network configuration method according to claim 27, wherein the communication means includes at least either of a telephone calling application or an electronic mail application.

29. The ad hoc network configuration method according to claim 28, wherein the terminal identifier includes at least either of a telephone number or an electronic mail address.

30. The ad hoc network configuration method according to claim 25, wherein the information on the terminal identifier contains at least a message digest that is calculated from the terminal identifier by a predetermined algorithm.

31. The ad hoc network configuration method according to claim 25, wherein the second terminal apparatus transmits ad hoc communication settings to the first terminal apparatus by way of the communication means of the second terminal apparatus when establishing the network.

32. The ad hoc network configuration method according to claim 31, wherein
the second terminal apparatus comprises storage means of storing a terminal identifier table that maintains a terminal identifier, and
the terminal identifier table is included in the ad hoc communication settings in order to control redistribution of setting information.

33. The ad hoc network configuration method according to claim 25, wherein the means of establishing the network transmits ad hoc communication settings to the first terminal apparatus by way of the communication means of the second terminal apparatus to permit participation of the first terminal apparatus in the network when ad hoc communication is already being performed with a terminal apparatus other than the first terminal apparatus.

34. The ad hoc network configuration method according to claim 25, wherein a transfer function provided by the communication means is utilized to transfer a request for participation of the first terminal apparatus in the network to an administrator's terminal apparatus.

35. The ad hoc network configuration method according to claim 25, wherein the wireless communication function is a short-distance wireless communication function including at least wireless Local Area Network (LAN).

36. The ad hoc network configuration method according to claim 25, wherein the first and the second terminal apparatuses are either portable terminals including at least portable telephones and Personal Digital Assistants (PDAs) or fixed terminals including at least fixed phones and Internet Protocol (IP) phones.

37. A program for an ad hoc network configuration method for use in a terminal apparatus that includes a wireless communication function to directly communicate with other terminals and communication means of performing communication over a communication network with the other terminals and that can form an ad hoc network using the wireless communication function, causing a computer to execute
a process of transmitting via the communication means a terminal identifier that is determined by the communication means to a communication party with which the terminal apparatus wants to form a network; a process of transmitting information on the terminal identifier to the communication party by way of the wireless communication function; a process of performing radio scan with the wireless communication function when a terminal identifier of the communication party is received by the communication means; a process of comparing the terminal identifier of the communication party received by the communication means with the information on the terminal identifier of the communication party received in the radio scan by the wireless communication function; and a process of establishing the network using the wireless communication function when a match is detected in the comparison.

38. A program for an ad hoc network configuration method for use in a terminal apparatus that includes a wireless communication function to directly communicate with other terminals and communication means of performing communication over a communication network with the other terminals and that can form an ad hoc network using the wireless communication function, causing a computer to execute
a process of transmitting via the communication means a terminal identifier that is determined by the communication means to a communication party with which the terminal apparatus wants to form a network; a process of transmitting the digest of the terminal identifier to the communication party by way of the wireless communication function; a process of performing radio scan with the wireless communication function when a terminal identifier of the communication party is received by the communication means; a process of calculating the digest of the terminal identifier received by the communication means; a process of comparing the calculated digest of the terminal identifier with the digest of the terminal identifier received in the radio scan by the wireless communication function; and a process of establishing the network using the wireless communication function when a match is detected in the comparison.
